(19) United States
(12) Patent Application Publication
(10) Pub. No.: US 2026/0008204 A1
(43) Pub. Date: Jan. 8, 2026

(54) METHOD FOR MANUFACTURING CEMENT COMPOSITION

(71) Applicant: TAIHEIYO CEMENT CORPORATION, Tokyo (JP)

(72) Inventors: Takayuki HAYAKAWA, Tokyo (JP); Toshinari ANNO, Tokyo (JP); Akiya OKADA, Tokyo (JP); Hiromichi TABA, Tokyo (JP); Sho HASEBE, Tokyo (JP)

(21) Appl. No.: 19/122,350

(22) PCT Filed: Dec. 13, 2023
(86) PCT No.: PCT/JP2023/044589

§ 371 Date: Apr. 18, 2025

(30) Foreign Application Priority Data
Dec. 26, 2022 (JP) 2022-209048

(51) Int. Cl. B28C 7/04

(52) U.S. Cl. CPC B28C 7/04

(57) ABSTRACT

A method of manufacturing a cement composition in which carbon dioxide is fixed and which uses cement, aggregate, and water, includes: mixing part of the cement and part of the water to obtain a cement slurry having a water to cement ratio of 250% or more; bringing the cement slurry into contact with a carbon dioxide gas to obtain a carbonated slurry; partially separating the water from the carbonated slurry to obtain a concentrated slurry having a liquid to solid ratio of 80% to 400%; kneading the concentrated slurry and remaining cement to obtain a highly concentrated cement-containing composition; and kneading the highly concentrated cement-containing composition and remaining water to obtain the cement composition, the aggregate being supplied in at least one of obtaining the highly concentrated cement-containing composition and obtaining the cement composition.

### TECHNICAL FIELD

The present invention relates to a method of manufacturing a cement composition (e.g., concrete in which carbon dioxide is fixed).

### BACKGROUND ART

In recent years, reduction in amount of carbon dioxide emission has become an important issue for suppressing global warming.

In relation to this, a technology of fixing carbon dioxide (carbon dioxide gas), which is included in an exhaust gas or the like generated in a cement manufacturing plant, in a cement composition such as concrete has been investigated.

For example, in Patent Literature 1, there is disclosed as a method of manufacturing concrete in which carbon dioxide is efficiently fixed, “a method of manufacturing concrete, including: forming a first mixture including cement and water; adding carbon dioxide to the first mixture to form a second mixture; and hardening the second mixture, wherein a weight of the water is adjusted so that 0% or more and 50% or less of unhydrated cement remains in the concrete” (claim 1).

In Patent Literature 2, there is disclosed as a method of manufacturing precast concrete achieving a significantly reduced amount of carbon dioxide emission by absorbing a large amount of carbon dioxide in a curing process, “a method of manufacturing carbon dioxide (CO₂)-absorbing precast concrete, including: pouring a concrete kneading material into a mold; and after removing a solidified product of concrete, subjecting the solidified product of concrete to carbonation and curing in an atmosphere having a carbon dioxide concentration of from 5% to 95%, to form a carbonated region at a site of a depth of 20 mm or more from a surface of the concrete” (claim 5).

The concrete kneading material used in the manufacturing method of Patent Literature 2 is “a concrete kneading material including, as powder components, one or two kinds of γ-C₂S (symbol γ) and steel slag powder (symbol B), and Portland cement (symbol C), wherein the concrete kneading material is blended so that a total of γ and B is from 25 mass % to 95 mass % with respect to a total content of the above-mentioned γ, B, and C, and a water to cement ratio W/C is from 80% to 250%” (claim 1).

### CITATION LIST

### Patent Literature

[Patent Literature 1] JP 2020-37493 A
[Patent Literature 2] JP 2011-168436 A

### SUMMARY OF INVENTION

### Technical Problem

An object of the present invention is to provide a method of manufacturing a cement composition in which carbon dioxide is fixed, the method allowing reduction in reaction time of cement and carbon dioxide and fixation of a large amount of carbon dioxide in the cement composition.

### Solution to Problem

The inventors of the present invention have made extensive investigations in order to achieve the above-mentioned object. As a result, the inventors have found that the object of the present invention can be achieved by a method of manufacturing a cement composition using cement, aggregate, and water, the method including: (A) a cement slurry preparation step of mixing part of the cement and part of the water to obtain a cement slurry having a water to cement ratio of 250% or more; (B) a carbonation step of bringing the cement slurry into contact with a carbon dioxide gas to obtain a carbonated slurry; (C) a concentration step of partially separating the water from the carbonated slurry to obtain a concentrated slurry having a liquid to solid ratio of from 80% to 400%; (D) an additional cement supply step of kneading the concentrated slurry and a remaining part of the cement to obtain a highly concentrated cement-containing composition; and (E) an additional water supply step of kneading the highly concentrated cement-containing composition and a remaining part of the water to obtain the cement composition, and having such a configuration that the aggregate is supplied in any one or both of the additional cement supply step and the additional water supply step. Thus, the inventors have completed the present invention.

The present invention provides the following items [1] to [8].

[1]A method of manufacturing a cement composition using cement, aggregate, and water, including:
a cement slurry preparation step of mixing part of the cement and part of the water to obtain a cement slurry having a water to cement ratio of 250% or more;
a carbonation step of bringing the cement slurry into contact with a carbon dioxide gas to obtain a carbonated slurry;
a concentration step of partially separating the water from the carbonated slurry to obtain a concentrated slurry having a liquid to solid ratio of from 80% to 400%;
an additional cement supply step of kneading the concentrated slurry and a remaining part of the cement to obtain a highly concentrated cement-containing composition; and
an additional water supply step of kneading the highly concentrated cement-containing composition and a remaining part of the water to obtain the cement composition,
wherein, in a total amount of the cement, a ratio of an amount of the part of the cement to be used in the cement slurry preparation step is from 1 mass % to 50 mass %, and a ratio of an amount of the remaining part of the cement to be used in the additional cement supply step is from 50 mass % to 99 mass %, and
wherein the aggregate is supplied in any one or both of the additional cement supply step and the additional water supply step.
   [2] The method of manufacturing a cement composition according to the above-mentioned item [1], wherein, in a total amount of the water included in the cement composition, a ratio of an amount of the water in the concentrated slurry obtained in the concentration step is from 50 mass % to 99 mass %, and a ratio of an amount of the remaining part of the water to be used in the additional water supply step is from 1 mass % to 50 mass %.
   [3] The method of manufacturing a cement composition according to the above-mentioned item [1] or [2], wherein a difference (X-Y) between the water to cement ratio (X) of the cement slurry obtained in the cement slurry preparation step and the liquid to solid ratio (Y) of the concentrated slurry obtained in the concentration step is 50% or more.
   [4] The method of manufacturing a cement composition according to any one of the above-mentioned items [1] to [3], wherein, in the carbonation step, the carbon dioxide gas is supplied as a gas containing 5 vol % or more of the carbon dioxide gas.
   [5] The method of manufacturing a cement composition according to any one of the above-mentioned items [1] to [4], wherein, in the carbonation step, the carbon dioxide gas is supplied until a pH of the carbonated slurry falls within a range of from 5.0 to 11.5.
   [6] The method of manufacturing a cement composition according to any one of the above-mentioned items [1] to [5], wherein the cement composition contains a cement admixture, and wherein the cement admixture is supplied in the additional water supply step.
   [7] The method of manufacturing a cement composition according to the above-mentioned item [6], wherein the cement admixture contains one or more kinds of cement dispersing agents selected from the group consisting of: a water reducing agent; an air entraining water reducing agent; a high range water reducing agent; and an air entraining and high range water reducing agent, and an air entraining agent.
   [8] The method of manufacturing a cement composition according to any one of the above-mentioned items [1] to [7], wherein the aggregate contains fine aggregate and coarse aggregate, and wherein a liquid to solid ratio of the cement composition is from 30% to 65%.

### Advantageous Effects of Invention

According to the method of manufacturing a cement composition of the present invention, the reaction time of the cement and carbon dioxide can be reduced.

According to the method of manufacturing a cement composition of the present invention, the amount of carbon dioxide to be fixed in the cement composition can be increased.

### DESCRIPTION OF EMBODIMENTS

A method of manufacturing a cement composition of the present invention is a method of manufacturing a cement composition using cement, aggregate, and water, including: (A) a cement slurry preparation step of mixing part of the cement and part of the water to obtain a cement slurry having a water to cement ratio of 250% or more; (B) a carbonation step of bringing the cement slurry into contact with a carbon dioxide gas (carbon dioxide having a form of a gas) to obtain a carbonated slurry; (C) a concentration step of partially separating the water from the carbonated slurry to obtain a concentrated slurry having a liquid to solid ratio of from 80% to 400%; (D) an additional cement supply step of kneading the concentrated slurry and a remaining part of the cement to obtain a highly concentrated cement-containing composition; and (E) an additional water supply step of kneading the highly concentrated cement-containing composition and a remaining part of the water to obtain the cement composition.

In the present invention, in the total amount (100 mass %) of the cement, the ratio of the amount of the cement (part) to be used in the step (A) (cement slurry preparation step) is from 1 mass % to 50 mass %, and the ratio of the amount of the cement (remaining part) to be used in the step (D) (additional cement supply step) is from 50 mass % to 99 mass %.

In the present invention, the aggregate (e.g., coarse aggregate and fine aggregate) is supplied in any one or both of the step (D) (additional cement supply step) and the step (E) (additional water supply step).

Each step is described in detail below.

### [Step (A): Cement Slurry Preparation Step]

The step (A) is a step of mixing part of the cement and part of the water, out of the total amount of the cement and the total amount of the water to be used in the manufacturing method of the present invention, to obtain a cement slurry having a water to cement ratio of 250% or more.

The cement is not particularly limited, and examples thereof include: various Portland cements, such as ordinary Portland cement, high-early-strength Portland cement, moderate-heat Portland cement, and low-heat Portland cement; mixed cements, such as blast furnace cement and fly ash cement; and ECO cement. Those cements may be used alone or in combination thereof.

In the total amount (100 mass %) of the cement included in the cement composition of the present invention, the ratio of the amount of the cement (part of the cement) to be used in the step (A) is from 1 mass % to 50 mass %, preferably from 3 mass % to 45 mass %, more preferably from 5 mass % to 40 mass %, still more preferably from 8 mass % to 35 mass %, still more preferably from 10 mass % to 32 mass %, particularly preferably from 12 mass % to 30 mass %. When the ratio is less than 1 mass %, the amount of carbon dioxide to be fixed in the cement composition is reduced. When the ratio is more than 50 mass %, strength developability of the cement composition is degraded.

The water to cement ratio of the cement slurry to be prepared in the step (A) is 250% or more, preferably from 300% to 2,000%, more preferably from 350% to 1,500%, still more preferably from 400% to 1,000%, particularly preferably from 450% to 700%.

When the ratio is less than 250%, the reduction in reaction time of the cement and carbon dioxide, which is the object of the present invention, cannot be sufficiently achieved. When the ratio is 2,000% or less, the efficiency of water separation treatment (concentration of carbonated slurry) in the subsequent step, that is, the step (C) (concentration step) can be increased further.

The term “water to cement ratio” refers to a mass ratio of water to cement (water/cement) in percentage (%), and is represented by the expression ([mass of water]×100/[mass of cement]; unit: %).

In the step (A), the method of mixing the cement and the water is not particularly limited, and examples thereof include: a method involving supplying water into storing and stirring means such as a stirring tank, and then supplying cement thereinto, followed by stirring; and a method involving simultaneously supplying water and cement into storing and stirring means, followed by stirring.

### [Step (B): Carbonation Step]

The step (B) is a step of bringing the cement slurry obtained in the step (A) into contact with a carbon dioxide gas to obtain a carbonated slurry.

In the step (B), it is preferred that the carbon dioxide gas be supplied while the cement slurry flows from the viewpoint of homogeneously supplying the carbon dioxide gas into the cement slurry.

Examples of the method of supplying the carbon dioxide gas into the cement slurry include the following methods (i) to (iii) (i) A method involving: providing, inside the stirring tank used in the step (A), carbon dioxide gas supply means for supplying the carbon dioxide gas into the cement slurry; and supplying the carbon dioxide gas into the cement slurry in the stirring tank

A more specific example of the method involves, in an apparatus provided with a stirring tank for stirring (mixing) cement and water to obtain a cement slurry and carbon dioxide gas supply means (e.g., air diffusion plate) arranged in the stirring tank, blowing a carbon dioxide gas into the cement slurry obtained in the step (A) by using the carbon dioxide gas supply means while stirring the cement slurry to obtain a carbonated slurry.

(ii) A method involving: introducing the cement slurry in the stirring tank into an apparatus having carbon dioxide gas supply means (e.g., air diffusion plate); then blowing the carbon dioxide gas into the cement slurry in the apparatus by using the carbon dioxide gas supply means to obtain a carbonated slurry; and then storing the carbonated slurry in a tank for storage

The stirring tank and the tank for storage may be the same or different from each other.

A more specific example of the method involves: introducing the cement slurry stored in the stirring tank into an apparatus having the carbon dioxide gas supply means (e.g., air diffusion plate) through a first passage by using a pump or the like and storing the cement slurry in the apparatus; then supplying the carbon dioxide gas into the cement slurry in the apparatus by using the carbon dioxide gas supply means while stirring the cement slurry; and then introducing the resultant carbonated slurry into the stirring tank through a second passage by using a pump or the like and storing the carbonated slurry therein.

An example of the apparatus is an apparatus provided with a slurry storage tank for storing and stirring the cement slurry, and air diffusion means (e.g., air diffusion plate) for carbon dioxide gas supply arranged in the slurry storage tank.

The cement slurry may be circulated repeatedly through the stirring tank, the first passage, the above-mentioned apparatus, and the second passage in the stated order until a sufficient amount of the carbon dioxide gas is fixed.

After the carbonated slurry is obtained, the carbonated slurry may be stored temporarily in a tank for storage different from the above-mentioned stirring tank, and supplied to another tank for storage from the tank for storage.

(iii) A method involving blowing a carbon dioxide gas into the cement slurry while supplying the cement slurry in the stirring tank into a tank for carbonated slurry storage

A more specific example of the method involves: introducing the cement slurry in the stirring tank into a pipeline connected to the stirring tank; supplying the carbon dioxide gas midway through the pipeline while causing the cement slurry to flow through the pipeline to obtain a carbonated slurry; and then storing the carbonated slurry in the tank for carbonated slurry storage.

An example of the pipeline is a pipeline having a carbon dioxide gas inlet and stirring means inside the pipeline for stirring the cement slurry and the carbon dioxide gas. A specific example thereof is a pipeline provided with air diffusion means (e.g., air diffusion plate) for supplying the carbon dioxide gas into the pipeline, and stirring means (e.g., line mixer or static mixer) inside the pipeline.

After the carbon dioxide gas is supplied into the cement slurry, the resultant carbonated slurry may be returned to the stirring tank without being introduced into the tank for carbonated slurry storage. The carbonated slurry may be circulated repeatedly through the stirring tank and the pipeline in the stated order until a sufficient amount of the carbon dioxide gas is fixed, and then introduced into the tank for carbonated slurry storage.

After the carbonated slurry is obtained, the carbonated slurry may be stored temporarily in a tank for storage different from the above-mentioned stirring tank, and supplied to the tank for carbonated slurry storage from the tank for storage.

From the viewpoint of increasing the amount of carbon dioxide to be fixed in the cement composition, the supply of the carbon dioxide gas may be performed under increased pressure on a liquid surface of the cement slurry (for example, by increasing the pressure of a gas phase above the liquid surface of a tank storing the cement slurry to 1,200 hPa or more, which is more than the atmospheric pressure).

In this way, it is preferred to use carbon dioxide gas supply means for supplying a carbon dioxide gas having a structure capable of increasing pressure.

In the present invention, the carbon dioxide gas may be supplied to the cement slurry as a gas formed of the carbon dioxide gas alone, but may be supplied to the cement slurry as a gas containing the carbon dioxide gas from the viewpoint of easy availability or the like.

In this case, the ratio of the carbon dioxide gas in the gas containing the carbon dioxide gas is preferably 5 vol % or more, more preferably 10 vol % or more, still more preferably 20 vol % or more, still more preferably 50 vol % or more, still more preferably 80 vol % or more, particularly preferably 90 vol % or more. When the ratio is 5 vol % or more, the amount of carbon dioxide to be fixed in the cement composition can be increased further. In addition, the time required for supply of the carbon dioxide gas can be reduced.

Examples of the gas containing the carbon dioxide gas include: an exhaust gas generated in a cement manufacturing process (carbon dioxide gas concentration: about 20 vol %); an exhaust gas generated in an steelmaking process (carbon dioxide gas concentration: about 20 vol %); an exhaust gas generated in a thermal power generation process (carbon dioxide gas concentration: about 10 vol %); and a separated and recovered gas from these exhaust gases (carbon dioxide gas concentration: about 100 vol %).

In the step (B), the supply of the carbon dioxide gas is performed so that the pH of the carbonated slurry falls within the range of preferably from 5.0 to 11.5, more preferably from 5.5 to 11.0, still more preferably from 6.0 to 10.0, particularly preferably from 6.5 to 9.0. When the pH is 5.0 or more, the strength developability of the cement composition is improved further. In addition, the time required for the supply of the carbon dioxide gas is reduced, and the manufacturing efficiency of the cement composition is improved further. When the pH is 11.5 or less, the amount of carbon dioxide to be fixed in the cement composition is increased further. By supplying the carbon dioxide gas, the pH of the carbonated slurry is reduced.

The supply time of the carbon dioxide gas varies depending on the water to cement ratio, the carbon dioxide gas supply means, the carbon dioxide gas concentration of the gas containing the carbon dioxide gas, and the like. Accordingly, in the step (B), the time to end the supply of the carbon dioxide gas is preferably determined based on the actually measured value of the pH of the carbonated slurry.

### [Step (C): Concentration Step]

The step (C) is a step of partially separating water from the carbonated slurry obtained in the step (B) (carbonation step) to obtain a concentrated slurry having a liquid to solid ratio of from 80% to 400%.

The phrase “partially separating water from the carbonated slurry” as used herein means not completely separating water in the carbonated slurry (i.e., dehydrating the carbonated slurry into only solid content), but separating only part of water in the carbonated slurry (i.e., concentrating the carbonated slurry so that the amount of water in the slurry is reduced).

The term “liquid to solid ratio” is a term corresponding to the “water to cement ratio” in the step (A) (cement slurry preparation step), and means a mass ratio of water (i.e., “liquid”) to “non-carbonated cement (uncarbonated cement) and cement as a material for a product (carbonated cement) obtained by carbonation of cement” (i.e., “solid”) in percentage (%) (water/[(uncarbonated cement)+(cement as material for carbonated cement)]), and is represented by the expression ([mass of water]×100/[total mass of uncarbonated cement and cement as material for carbonated cement]; unit: %).

The term “concentrated slurry” means a product obtained by partially separating water from the cement slurry obtained in the step (A) (cement slurry preparation step).

The term “concentrated slurry” is not limited to a slurry-like product, and also includes a product not referred to as “slurry” (e.g., mortar-like product).

In the step (C), the liquid to solid ratio is from 80% to 400%. When the liquid to solid ratio is less than 80%, the strength developability of the cement composition after hardening is degraded. When the liquid to solid ratio is more than 400%, the amount of carbon dioxide to be fixed in the cement composition is reduced.

The liquid to solid ratio is, from the viewpoint of obtaining excellent strength developability, preferably 100% or more, more preferably 150% or more, still more preferably 200% or more, particularly preferably 250% or more.

The liquid to solid ratio is, from the viewpoint of increasing the amount of carbon dioxide to be fixed, preferably 300% or less, more preferably 250% or less, still more preferably 200% or less, particularly preferably 150% or less.

In the present invention, a difference (X-Y) between the water to cement ratio (X) of the cement slurry obtained in the step (A) (cement slurry preparation step) and the liquid to solid ratio (Y) of the concentrated slurry obtained in the step (C) (concentration step) is preferably 50% or more, more preferably 100% or more, still more preferably 150% or more, particularly preferably 200% or more.

When the difference (X-Y) is 50% or more, the amount of carbon dioxide to be fixed in the cement composition can be increased further.

The upper limit of the difference (X-Y) is not particularly limited, but is, for example, 1,800% (generally, 1,200%).

In the total amount (100 mass %) of water included in the cement composition, which is the target product of the manufacturing method of the present invention, the ratio of the amount of water in the concentrated slurry obtained in the step (C) (concentration step) is preferably from 50 mass % to 99 mass %.

When the ratio is 50 mass % or more, the strength developability of the cement composition after hardening can be improved further. When the ratio is 99 mass % or less, the amount of carbon dioxide to be fixed in the cement composition can be increased further.

The ratio is, from the viewpoint of obtaining excellent strength developability, preferably 60 mass % or more, more preferably 70 mass % or more, still more preferably 75 mass % or more, particularly preferably 80 mass % or more.

The ratio is, from the viewpoint of increasing the amount of carbon dioxide to be fixed, preferably 90 mass % or less, more preferably 80 mass % or less, still more preferably 70 mass % or less, particularly preferably 65 mass % or less.

In the step (C) (concentration step), a known solid-liquid separation device, such as a precipitator, a vacuum dehydrator, or a pressure dehydrator, may be used as means for separating water.

### [Step (D): Additional Cement Supply Step]

The step (D) is a step of kneading the concentrated slurry obtained in the step (C) (concentration step) and the remaining part of the cement to obtain a highly concentrated cement-containing composition (composition containing cement at a higher concentration than that of the concentrated slurry obtained in the step (C) by addition of the cement).

In the total amount (100 mass %) of the cement included in the cement composition of the present invention, the ratio of the amount of the cement (remaining part of the cement) to be used in the step (D) is from 50 mass % to 99 mass %, preferably from 55 mass % to 97 mass %, more preferably from 60 mass % to 95 mass %, still more preferably from 65 mass % to 92 mass %, still more preferably from 68 mass % to 90 mass %, particularly preferably from 70 mass % to 88 mass %. When the ratio is less than 50 mass %, the strength developability of the cement composition after hardening is degraded. When the ratio is more than 99 mass %, the amount of carbon dioxide to be fixed in the cement composition is reduced.

### [Step (E): Additional Water Supply Step]

The step (E) is a step of kneading the highly concentrated cement-containing composition obtained in the step (D) and the remaining part of the water to obtain the cement composition (composition containing cement at a lower concentration than that of the highly concentrated cement-containing composition obtained in the step (D) by addition of the water).

In the total amount (100 mass %) of water included in the cement composition, which is the target product of the manufacturing method of the present invention, the ratio of the amount of water (remaining part) to be supplied in the step (E) is preferably from 1 mass % to 50 mass %.

When the ratio is 1 mass % or more, the amount of carbon dioxide to be fixed in the cement composition can be increased further. When the ratio is 50 mass % or less, the strength developability of the cement composition after hardening can be improved further.

The ratio is, from the viewpoint of increasing the amount of carbon dioxide to be fixed, preferably 10 mass % or more, more preferably 20 mass % or more, still more preferably 30 mass % or more, particularly preferably 35 mass % or more.

The ratio is, from the viewpoint of obtaining excellent strength developability, preferably 40 mass % or less, more preferably 30 mass % or less, still more preferably 25 mass % or less, particularly preferably 20 mass % or less.

In the present invention, the aggregate is supplied in any one or both of the step (D) (additional cement supply step) and the step (E) (additional water supply step).

The aggregate is preferably supplied in the step (D) (additional cement supply step) from the viewpoint of the manufacturing efficiency of the cement composition.

The aggregate to be used in the present invention is, for example, fine aggregate alone, or a combination of the fine aggregate and coarse aggregate. Any of natural aggregate, artificial aggregate, and recycled aggregate may be used as the aggregate.

The fine aggregate is not particularly limited, and examples thereof include river sand, mountain sand, land sand, sea sand, crushed sand, silica sand, slag fine aggregate, lightweight fine aggregate, and a mixture of two or more kinds selected therefrom.

The coarse aggregate is not particularly limited, and examples thereof include river gravel, mountain gravel, land gravel, sea gravel, crushed stone, slag coarse aggregate, lightweight coarse aggregate, and a mixture of two or more kinds selected therefrom.

The blending amount of the aggregate (when the fine aggregate and the coarse aggregate are used in combination, the blending amount of each aggregate) is not particularly limited, and may be a general blending amount in mortar or concrete.

When the fine aggregate and the coarse aggregate are used in combination, for example, the unit amount of the fine aggregate may be set to from 600 kg/m³ to 1,100 kg/m³, the unit amount of the coarse aggregate may be set to from 800 kg/m³ to 1,500 kg/m³, and a sand percentage may be set to from 30% to 60%.

The term “sand percentage” refers to a mass (A) of the fine aggregate in the total of the mass (A) of the fine aggregate and the mass (B) of the coarse aggregate in percentage (%), and is represented by the expression (A×100/(A+B); unit: %).

The liquid to solid ratio of the cement composition is preferably from 30% to 65%, more preferably from 40% to 60%.

When the ratio is 30% or more, fluidity of the cement composition is improved further. When the ratio is 65% or less, the strength developability of the cement composition is improved further.

The cement composition preferably contains a cement admixture from the viewpoint of further improving an air entrainment property and the fluidity.

Examples of the cement admixture include a cement dispersing agent and an air entraining agent. In particular, the cement dispersing agent and the air entraining agent are preferably used in combination from the viewpoint of further improving the air entrainment property and the fluidity.

Examples of the cement dispersing agent include a water reducing agent, an air entraining water reducing agent, a high range water reducing agent, and an air entraining and high range water reducing agent.

The amount of the cement dispersing agent is, for example, from 0.5 part by mass to 3 parts by mass (preferably from 1.0 part by mass to 2.0 parts by mass) with respect to 100 parts by mass of the cement.

The cement dispersing agent is preferably supplied in the step (E) (additional water supply step) from the viewpoint of further improving the air entrainment property and the fluidity of the cement composition.

The amount of the air entraining agent is, for example, from 0.001 part by mass to 0.03 part by mass (preferably from 0.003 part by mass to 0.02 part by mass) with respect to 100 parts by mass of the cement.

The cement composition may contain various admixtures, such as fly ash, silica fume, and ground granulated blast-furnace slag as required.

The amount of the admixture is preferably 30 parts by mass or less, more preferably 20 parts by mass or less, still more preferably 10 parts by mass or less, particularly preferably 5 parts by mass or less with respect to 100 parts by mass of the cement.

In the manufacturing method of the present invention, the step of using various admixtures is not particularly limited, but is preferably performed in at least one of the step (D) (additional cement supply step) or the step (E) (additional water supply step) from the viewpoints of the manufacturing efficiency of the cement composition, not affecting the pH of the carbonated slurry in the step (B) (carbonation step), and the like.

### EXAMPLES

Now, the present invention is more specifically described by way of Examples. However, the present invention is not limited to Examples.

### Used Material

(1) Cement: Ordinary Portland Cement (manufactured by TAIHEIYO CEMENT CORPORATION)
(2) Fine aggregate: mountain sand
(3) Coarse aggregate: crushed stone
(4) Water: tap water
(5) Air entraining water reducing agent: product name “MasterPolyheed 15S” (manufactured by Pozzolith Solutions Ltd.)
(6) Air entraining agent: product name “MasterAir 303A” (Pozzolith Solutions Ltd.)

### [A. Experiment on Water to Cement Ratio in Cement Slurry Preparation Step]

### Examples 1 to 4 and Comparative Example 1

The cement and water in amounts shown in Table 1 were kneaded in a vessel for 60 seconds by using a hand mixer, and a cement slurry (liquid temperature: 23° C.) was obtained. A carbon dioxide gas (concentration: 100%) was blown into the cement slurry in the vessel through a carbon dioxide gas supply tube at a rate of 20 L/min, and a carbonated slurry was obtained (completion of carbonation step).

A time period from the start of the blowing of the carbon dioxide gas to the time when the pH of the carbonated slurry had reached equilibrium within the range of from 6 to 7 (time at the end of the reaction) was referred to as “reaction time (min)”.

Table 1 shows the reaction time.

From Table 1, it can be recognized that as the water to cement ratio increases more, the reaction time decreases more.

TABLE 1

| | Comparative | | | | |
|---|---|---|---|---|---|
| | Example 1 | Example 1 | Example 2 | Example 3 | Example 4 |
| Water to cement | 200 | 300 | 500 | 1,000 | 1,500 |
| ratio (%) | | | | | |
| Water (g) | 1,000 | 1,500 | 2,500 | 5,000 | 7,500 |
| Cement (g) | 500 | 500 | 500 | 500 | 500 |
| Reaction | 410 | 130 | 120 | 105 | 100 |
| time (min) | | | | | |

### [B. Experiment on Liquid to Solid Ratio in Concentration Step]

### Examples 5 to 7 and Comparative Example 2

The carbonated slurry obtained in Example 2 (water to cement ratio: 500%) was left to stand still so that solid contents (cement and carbonated cement) were precipitated. Next, water was removed by using a submersible pump, and the liquid to solid ratio was adjusted to values shown in Table 2 (completion of concentration step). In Comparative Example 2, removal of water was not performed.

The remaining part of the cement, the fine aggregate, and the coarse aggregate were loaded into the resultant concentrated slurry, and the mixture was kneaded for 60 seconds, to thereby obtain a highly concentrated cement-containing composition (completion of additional cement supply step).

Next, water and admixtures (air entraining water reducing agent and air entraining agent) in amounts shown in Table 2 were loaded into the resultant highly concentrated cement-containing composition, and the mixture was kneaded for 60 seconds. Next, a kneaded product adhering to the inner wall of the mixer was scraped off, and the mixture was then kneaded for another 60 seconds, to thereby obtain concrete (cement composition) (completion of additional water supply step).

The slump of the resultant concrete was measured in conformity with “JIS A 1101:2020 (Method of test for slump of concrete)”.

The compressive strength of the resultant concrete at 7 days and 28 days after its preparation was measured in conformity with “JIS A 1108:2018 (Method of test for compressive strength of concrete)”.

The ratio (mass %) of carbon dioxide in the 7-days-old specimen used for measuring the compressive strength was determined through thermogravimetry-differential thermal analysis (TG-DTA). Specifically, thermogravimetry-differential thermal analysis (TG-DTA) was performed, and from the measurement results, reduction in mass within an endothermic peak range of from about 550° C. to about 800° C. was judged to be due to decarbonation of calcium carbonate included in a mortar portion of the concrete. From the amount of the reduction in mass, the ratio (mass %:value of calcium carbonate in terms of carbon dioxide) of carbon dioxide in the mortar portion was calculated, and the amount of carbon dioxide fixed per ton of the cement was determined.

[C. Experiment without Carbonation]

### Comparative Example 3

The cement in a unit amount 336 kg/m³, the fine aggregate in a unit amount of 840 kg/m³, and the coarse aggregate in an amount of 938 kg/m³ were loaded into a 55-liter forced pan mixer, and the mixture was subjected to dry kneading for 30 seconds. Then, the water in a unit amount of 168 kg/m³ and the admixtures were loaded thereinto, and the mixture was kneaded for 60 seconds. Next, a kneaded product adhering to the inner wall of the mixer was scraped off, and the mixture was kneaded for another 60 seconds, to thereby obtain concrete (cement composition).

The results are shown in Table 3.

From Table 3, it can be recognized that the amount of carbon dioxide fixed in the mortar portion of each of Examples 5 to 7 is larger than that of each of Comparative Examples 2 and 3.

TABLE 2

| | | | | | | Composition obtained in additional | | | | | | | |
|---|---|---|---|---|---|---|---|---|---|---|---|---|---|
| | Concentrated slurry obtained | | | | | cement supply step | | | | | | | |
| | in concentration step | | | | | Remaining | | | | Water and the like supplied in | | | |
| | Liquid | Part of | | | | part of | | Fine | Coarse | additional water supply step | | | |
| | to solid | cement | | Water | | cement | | aggre- | aggre- | Water | | | |
| | ratio | (kg/ | | (kg/ | | (kg/ | | gate | gate | (kg/ | | 15S⁵⁾ | 303A⁶⁾ |
| | (Mass %) | m³) | (Mass %) ¹⁾ | m³) | (Mass %) ²⁾ | m³) | (Mass %) ³⁾ | (kg/m³) | | m³) | (Mass %) ⁴⁾ | (Mass %) ⁷⁾ | |
| Exam- | 100 | 100.8 | 30.0 | 100.8 | 60.0 | 235.2 | 70.0 | 840 | 938 | 67.2 | 40.0 | 1.4 | 0.004 |
| ple 5 | | | | | | | | | | | | | |
| Exam- | 200 | 67.2 | 20.0 | 134.4 | 80.0 | 268.8 | 80.0 | | | 33.6 | 20.0 | 1.4 | 0.004 |
| ple 6 | | | | | | | | | | | | | |
| Exam- | 300 | 50.0 | 14.9 | 150.0 | 89.3 | 286.0 | 85.1 | | | 18.0 | 10.7 | 1.6 | 0.012 |
| ple 7 | | | | | | | | | | | | | |
| Compar- | 500 | 33.6 | 10.0 | 168.0 | 100 | 302.4 | 90.0 | 840 | 938 | — | — | 1.6 | 0.008 |
| ative | | | | | | | | | | | | | |
| Exam- | | | | | | | | | | | | | |
| ple 2 | | | | | | | | | | | | | |
| Compar- | — | — | — | — | — | 336.0 | 100 | | | 168.0 | 100 | 1.4 | 0.006 |
| ative | | | | | | | | | | | | | |
| Exam- | | | | | | | | | | | | | |
| ple 3 | | | | | | | | | | | | | |

¹⁾ Ratio (mass %) of amount of part of cement in total amount of cement
²⁾ Ratio (mass %) of amount of water in concentrated slurry in total amount of water included in cement composition
³⁾ Ratio (mass %) of amount of remaining part of cement in total amount of cement
⁴⁾ Ratio (mass %) of amount of water supplied in additional water supply step in total amount of water included in cement composition
⁵⁾15S: Air entraining water reducing agent
⁶⁾303A: Air entraining agent
⁷⁾ Part(s) by mass with respect to 100 parts by mass of cement
⁵⁾Air entraining water reducing agent: product name “MasterPolyheed 15S” (manufactured by Pozzolith Solutions Ltd.)
⁶⁾Air entraining agent: product name “MasterAir 303A” (Pozzolith Solutions Ltd.)

TABLE 3

| | | | | | | (2) Amount of | (3) Amount of | (4) Amount of |
|---|---|---|---|---|---|---|---|---|
| | | | Compressive | | (1) Amount of | carbon dioxide | carbon dioxide | carbon dioxide |
| | | | strength | | carbon dioxide | fixed in mortar | fixed in mortar | fixed in mortar |
| | | Amount | (N/mm²) | | fixed in mortar | portion | portion | portion |
| | Slump | of air | 7 | 28 | portion | (kg/mortar − | (kg/t − | (kg/t − |
| | (cm) | (%) | days | days | (mass %) | m³) ¹⁾ | cem) ²⁾ | cem) ³⁾ |
| Example 5 | 19.0 | 4.5 | 14.0 | 26.8 | 5.02 | 112 | 201 | 125 |
| Example 6 | 18.5 | 4.6 | 20.2 | 34.3 | 2.73 | 61.2 | 109 | 34 |
| Example 7 | 18.0 | 4.5 | 30.1 | 47.3 | 2.61 | 58.5 | 104 | 29 |
| Comparative | 10.5 | 3.5 | 30.8 | 46.9 | 2.31 | 51.7 | 92 | 17 |
| Example 2 | | | | | | | | |
| Comparative | 18.5 | 4.8 | 29.4 | 45.6 | 1.89 | 42.3 | 76 | — |
| Example 3 | | | | | | | | |

¹⁾ Amount of carbon dioxide fixed in 1 m³ of mortar portion
²⁾ Amount of carbon dioxide fixed in mortar portion in terms of 1 ton of cement
³⁾ Amount of carbon dioxide fixed in mortar portion in terms of 1 ton of cement by carbonated slurry (value obtained by subtracting value of Comparative Example 3 from each value of (3))

1. A method of manufacturing a cement composition using cement, aggregate, and water, comprising:
a cement slurry preparation step of mixing part of the cement and part of the water to obtain a cement slurry having a water to cement ratio of 250% or more;
a carbonation step of bringing the cement slurry into contact with a carbon dioxide gas to obtain a carbonated slurry;
a concentration step of partially separating the water from the carbonated slurry to obtain a concentrated slurry having a liquid to solid ratio of from 80% to 400%;
an additional cement supply step of mixing the concentrated slurry and a remaining part of the cement to obtain a highly concentrated cement-containing composition; and
an additional water supply step of mixing the highly concentrated cement-containing composition and a remaining part of the water to obtain the cement composition,
wherein, in a total amount of the cement, a ratio of an amount of the part of the cement to be used in the cement slurry preparation step is from 1 mass % to 50 mass %, and a ratio of an amount of the remaining part of the cement to be used in the additional cement supply step is from 50 mass % to 99 mass %,
wherein the aggregate is supplied in any one or both of the additional cement supply step and the additional water supply step,
wherein, in a total amount of the water included in the cement composition, a ratio of an amount of the water in the concentrated slurry obtained in the concentration step is from 50 mass % to 99 mass %, and a ratio of an amount of the remaining part of the water to be used in the additional water supply step is from 1 mass % to 50 mass %,
wherein a difference (X-Y) between the water to cement ratio (X) of the cement slurry obtained in the cement slurry preparation step and the liquid to solid ratio (Y) of the concentrated slurry obtained in the concentration step is 50% or more.

2. (canceled)

3. (canceled)

4. The method of manufacturing a cement composition according to claim 1, wherein, in the carbonation step, the carbon dioxide gas is supplied as a gas containing 5 vol % or more of the carbon dioxide gas.

5. The method of manufacturing a cement composition according to claim 1, wherein, in the carbonation step, the carbon dioxide gas is supplied until a pH of the carbonated slurry falls within a range of from 5.0 to 11.5.

6. The method of manufacturing a cement composition according to claim 1,
wherein the cement composition comprises a cement admixture, and
wherein the cement admixture is supplied in the additional water supply step.

7. The method of manufacturing a cement composition according to claim 6, wherein the cement admixture comprises one or more kinds of cement dispersing agents selected from the group consisting of: a water reducing agent; an air entraining water reducing agent; a high range water reducing agent; and an air entraining and high range water reducing agent, and an air entraining agent.

8. The method of manufacturing a cement composition according to claim 1,
wherein the aggregate comprises fine aggregate and coarse aggregate, and
wherein a liquid to solid ratio of the cement composition is from 30% to 65%.
